(19) United States
(12) Patent Application Publication
(10) Pub. No.: US 2007/0049145 A1
(43) Pub. Date: Mar. 1, 2007

(54) Filter tape

(76) Inventor: Johannes Wilhelmus Gerardus Hooft, Hagestein (NL)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/391,634

(22) Filed: Sep. 26, 2005

Related U.S. Application Data
(63) Continuation of application No. 10/111,038, filed on Sep. 17, 2002, now abandoned.

(30) Foreign Application Priority Data
Oct. 18, 1999 (NL) 1013320

(51) Int. Cl. B32B 27/04; B32B 27/12

(52) U.S. Cl. 442/123

(57) ABSTRACT

A filter tape comprising a dustproof but ventilating textile fabric (1) which is provided with an anti-fungal and anti-algal agent to keep the pores (2) therein open. The anti-fungal and anti-algal agent comprises a first substance (5) that is not water-soluble, or hardly so, but that is nevertheless capable of entering into an in situ reaction with forming of an active second substance, that is considerably more readily water soluble. At least this second substance is toxic to fungi and algae. By thus starting from a non-soluble source for the active second substance, a time-release action is obtained whereby the anti-fungal and anti-algal action will be less rapidly exhausted. The ventilation and filter action of the fabric can be adjusted as required by means of an adaptable pattern (6). Optionally self adhesive traces (3) on one of the two sides of the filter tape, optionally protected by a protective sheet (4), enable simple mounting.

The present invention relates to a filter tape comprising a dustproof but ventilating textile fabric which is provided with an anti-fungal and anti-algal agent. It is noted here that where reference is made of a textile fabric in the present invention, this should be understood to mean not only structures woven from yarns or filaments but particularly also non-woven materials, which are normally built up of optionally oriented, short (synthetic) fibres.

Such tape material is applied on a relatively large scale for sealing of cavities in dustproof but water and water vapour-permeable manner, for instance of double or even multi-walled plate material. This plate material is employed particularly for walls and roofs of conservatories, light corridors and other applications, wherein a relatively light but shock-resistant construction is desirable, which is to a great extent transparent or at least translucent. The plate material herein usually comprises two translucent plastic plate parts which are held at a mutual distance by a number of substantially parallel spacers. In this manner the spacers and the two plate parts enclose a number of elongate cavity channels which debouch on an edge of the plate material running transversely of the spacers. In order to prevent dirt and dust penetrating into these cavity channels, a seal is desired here which stops dust and dirt but nevertheless ventilates so to enable the discharge of moisture, such as condensed water, possibly present in the cavity channels. The filter tape of the type stated in the preamble provides such a seal.

A problem which can occur in practice is that, partly due to the presence of moisture, algae and fungi may settle on the filter tape, whereby the ventilating pores therein may eventually become blocked. In order to prevent this the textile fabric from which the known filter tape is formed is impregnated as the case arises with an anti-fungal and anti-algal agent which aims to prevent the growth of these micro-organisms. This is always a substance which is water-soluble and toxic to algae and fungi. If (cavity) moisture comes into contact with the filter tape, the active substance will dissolve and thus have its fungicidal and algicidal effect.

A drawback of the known filter tape provided with an anti-algal and anti-fungal agent is however that the active concentration of the agent will initially be relatively high but will subsequently decrease steadily until the quantity of the agent in the filter tape is almost completely exhausted. While increasing the initial quantity of agent on the filter tape does prolong the algicidal and fungicidal action, limits are imposed hereon and a higher starting concentration will moreover also lead initially to a more rapid exhaustion of the agent. All in all, the algicidal and fungicidal action of the existing filter tape is often found in practice to be significantly shorter than the lifespan of the building on which it is arranged. As a result algal growth and fungus formation will still occur after a time, which not only stains but also adversely affects the ventilating action of the filter tape.

The present invention has for its object, among others, to provide a filter tape of the type stated in the preamble which is capable of preventing the growth and formation of algae and fungi for a longer period.

In order to achieve the stated objective a filter tape according to the invention has the feature that the anti-fungal and anti-algal agent comprises a first substance which is not water-soluble, or hardly so, but which is nevertheless capable of entering into an in situ reaction with forming of an active second substance, which is considerably more readily water-soluble and is toxic to fungi and algae. Instead of an active substance which dissolves immediately in the case of contact with water, the filter tape according to the invention has an anti-algal and anti-fungal agent which is at least practically water-insoluble but which enters into a reaction in situ, for instance in the air or in contact with water, to form a second substance toxic to algae and fungi which does dissolve in water. Not only will the active concentration of the agent thus be significantly more constant during the lifespan than in the case of an agent which dissolves directly, but a sufficiently great effective “supply” of the agent in the filter tape according to the invention can be chosen so as to ensure an adequate anti-fungal and anti-algal action over a sufficient part of the lifespan of the substrate on which the filter tape is applied. Nor is this action limited here solely to the filter tape itself, but extends to all construction parts located “downstream” of the moisture discharged by the filter tape.

In a particular embodiment the filter tape according to the invention has the feature that the first substance is a metal and the second substance comprises an associated metal oxide which is at least moderately soluble in water. Metals are not water-soluble but form as the occasion arises, particularly in the presence of water, a water-soluble oxide which is soluble. A small quantity of metal in the filter tape is already found in practice to be sufficient to ensure forming of the metal oxide for a very long time. By taking a metal which thus forms an oxide toxic to fungi and algae, the algicidal and fungicidal action of the filter tape can be guaranteed for a long period.

A preferred embodiment of the filter tape according to the invention has in this respect the feature that the metal comprises copper. Copper is one of those metals which, if exposed to air and particularly to moisture, forms a copper oxide extremely toxic to algae and fungi. A very small concentration of copper oxide already suffices for effective prevention of fungi and the growth of algae. Because copper is a relatively noble metal, oxidation thereof only takes place slowly, whereby the anti-algal and anti-fungal action is ensured for a long lifespan.

In order to prevent fragments of the first substance becoming detached from the textile fabric, a further particular embodiment of the filter tape according to the invention has the feature that the textile fabric comprises fibres which are at least to a considerable extent at least practically encased with the first substance. By thus encasing the fibres with the first substance, for instance by vapour deposition of the first substance or by placing or saturating the textile fabric in a melt or solution of the first substance, the first substance is as it were anchored in the textile fabric. Thus is prevented that, as a result of the liquid flowing through the textile fabric, parts of the first substance become detached and are subsequently entrained therein. This would result in an undesirably rapid exhaustion of the “supply” of the agent in the filter tape.

Because the invention prevents blocking of the pores therein with fungi and algae for at least a sufficiently large part of the lifespan of the filter tape, the ventilating action thereof is ensured at all times. There need not therefore be any fear of an unacceptable fall in the ventilation value during the lifespan. Nor will the absolute number of pores which is statistically inevitably too large to properly filter dust and dirt from the airflow decrease as a result of being closed by algal and fungal growth. For applications where this absolute number has to be reduced or where the ventilation value, perhaps partly as a result hereof, may be too high, for instance to achieve a determined degree of thermal insulation for the cavity closed therewith, the invention provides a further particular embodiment of the filter tape, which further embodiment has the feature that the textile fabric is provided with a pattern which at least almost completely closes the textile fabric locally but leaves ventilating parts open therebetween. Because the pores in the textile fabric are at least almost completely closed at the location of the pattern, ventilation will no longer be able to take place here and the total number of pores which are too large can be reduced. By thus closing a larger part or a smaller part of the total surface of the filter tape, for instance by choosing a suitable density of the pattern, the total filter and ventilation value of the filter tape can thus be adjusted as desired.

A further embodiment of the filter tape has the feature according to the invention that the pattern is arranged in the textile fabric itself by compacting the material thereof mechanically and/or thermally in pattern-like manner. The pattern can thus be arranged in the textile fabric material for instance by calendering or embossing, wherein if desired the textile fabric material is also locally melted at increased temperature, in the case of a thermoplastic fabric material such as many plastics. In another embodiment the filter tape according to the invention has the feature that the pattern comprises an at least practically airtight material which is arranged on the textile fabric. In this case the filter tape is then covered with a layer in the desired pattern which at least almost completely closes the pores in the filter tape at that position. All this can be achieved relatively easily by means of screen-printing, a lift-off process or any other lithographic technique. A further particular embodiment of the filter tape has in this respect the feature that the pattern contains the first substance.

In order to facilitate processing of the filter tape, a further particular embodiment thereof has the feature according to the invention that the textile fabric is provided along opposite longitudinal sides thereof with at least a trace of an adhesive, and in particular that the adhesive is self-adhesive and is covered with a removable protective sheet. The filter tape can thus be arranged directly onto a substrate, without additional assist means such as glue or any other fixing means being required.

The invention will now be further elucidated with reference to an embodiment and an associated drawing. In the drawing:

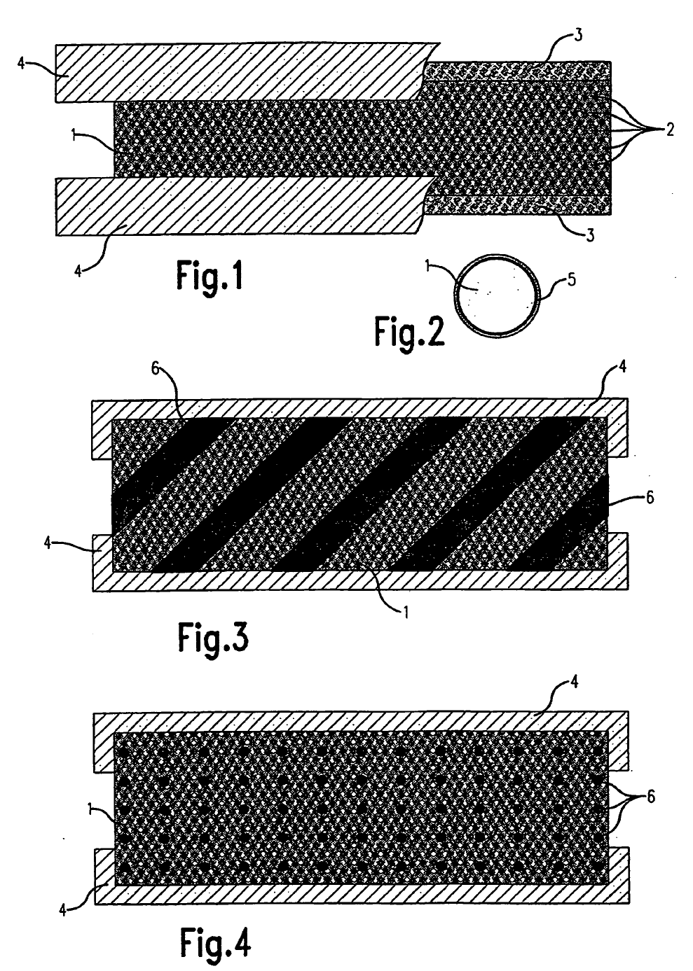

FIG. 1 shows a first embodiment of the filter tape according to the invention;

FIG. 2 shows a cross-section through a fibre of the filter tape of FIG. 1;

FIG. 3 shows a second embodiment of the filter tape according to the invention; and

FIG. 4 shows a third embodiment of the filter tape according to the invention.

The figures are purely schematic and not drawn to scale. For the sake of clarity some dimensions in particularly are show (highly) exaggerated. Corresponding parts are designated in the figures as far as possible with the same reference numerals.

In the first embodiment of the filter tape according to the invention shown in FIG. 1 the filter tape comprises a non-woven textile fabric 1 of polyester or other suitable material, such as for instance polypropylene, polyethylene or a polyamide. This fabric is characterized by a non-woven structure in which pores 2 are left open at locations which may or may not be at random, which pores are typically between 10 μm and 50 μm in size. Such pore sizes allow transport of water and water vapour through the fabric, but are generally too small for dirt particles, dust, pollen, fungus spores and the like, which are therefore stopped by the fabric. The filter tape described here is therefore highly suitable for sealing spaces, such as particularly the cavities in multi-walled plate material, in a manner which is dirtproof and dustproof but which allows passage of water and water vapour. For processing of the filter tape a track 3 of adhesive, in this case of a self-adhesive nature, is arranged along both opposite longitudinal edges, whereby the filter tape can be glued directly onto a substrate. A protective foil 4 protects both self-adhesive glue tracks beforehand against fouling.

The dirt particles which are stopped by the filter tape usually comprise a combination of organic and inorganic products and in combination with moisture form an almost ideal breeding ground for (micro-)organisms such as fungi and algae. In order to prevent excessive growth thereof blocking the pores in the filter tape after a period of time, the filter tape is treated with an anti-algal and anti-fungal agent. In the embodiment of a filter tape shown here, an agent is used for this purpose according to the invention in the form of a first substance which is not water-soluble, or hardly so, but which is capable during use of entering into a reaction with the environment to form a second substance which is considerably better soluble in water and has an algicidal and fungicidal action. An example of such an agent is a number of metals which form a water-soluble toxic oxide if exposed to an environment of water an air. In this respect copper is used in the present embodiment as such a metal. In a moist environment copper forms copper oxide, which is water-soluble and is found to be particularly efficient in effectively preventing the growth of algae and fungi.

By thus starting from a non-soluble first substance as source as it were for the active second substance, the first substance will be less rapidly exhausted than if the first substance were to go into the solution. Instead of an initially high concentration of active substance which then decreases comparatively quickly, which would be the case if the first substance were itself soluble and active, the concentration of active substance in the filter tape according to the invention can be considerably more constant because this not only depends on the solubility of the active second substance but depends above all on the oxidation speed of the first substance. The active substance in the filter tape according to the invention is moreover the reaction product of the first substance, oxygen and water, only one component of which need be included in sufficient quantity in the filter tape. The effective supply of active substance can hereby be relatively large. All in all, an exceptionally long-lasting action can thus be obtained using the same quantity of anti-algal and anti-fungal product. As result the draining function of the filter tape can be ensured for a long time.

In the present case the copper is applied by vapour-deposition, which results, at least to a large extent, in the fibres of the fabric material being completely covered all around with a copper layer. This is shown further in cross-section in FIG. 2. By adjusting the vapour-deposition process the thickness of copper layer 5 can be varied from less than 1 μm to a few micrometres as according to requirements. Because the copper layer deposits relatively homogeneously on the fibres from various sides, it as it were grabs around the fibres and is anchored therein. Copper parts are thus prevented from detaching prematurely and being flushed away. A copper layer with a thickness of a few tenths of a gram to a few grams per square metre is found in practice to be effective in precluding, or at least sufficiently preventing, fungal and algal growth for a long period.

In some cases it may be desirable for the filter tape to ventilate to a lesser extent than is the case with the tape of FIG. 1. This is for instance important if the cavity which is closed with the filter tape must have a certain minimal degree of ventilation. This need will be particularly felt now that owing to the invention fungal and algal growth is prevented effectively and free ventilation of the pores in the filter tape is thereby guaranteed for a long period and will not decrease rapidly. The embodiment of the filter tape according to the invention shown in FIG. 3 provides a solution for these cases. The filter tape is largely comparable to that of FIG. 1, be it that in this case a pattern 6 is subsequently arranged on fabric 1, which pattern completely closes the pores therein locally. In this embodiment the pattern 6 is formed by an air and watertight lacquer coating which is applied by screen-printing. The pattern can herein be chosen such that practically the exact desired degree of ventilation results. The stripe width and the mutual pitch in the stripe pattern can thus for instance be varied so as to thus cover a larger or smaller part of the total surface area of the fabric. Other lacquer patterns which may or may not be continuous can also be employed to obtain the desired result. If desired, a colour can be used for the lacquer pattern which enhances the appearance of the filter tape. In similar manner the absolute number of pores which are too large can be reduced, if desired, by covering random pores with the pattern.

Instead of being arranged later, the pattern can also be arranged simultaneously with the manufacture of the textile fabric. This is for instance the case in a third embodiment of the filter tape according to the invention which is shown in FIG. 4. In this case a relief has been worked into the fabric during manufacture of the non-woven fabric material of synthetic fibres at increased temperature. The fabric material is hereby fused locally to an impenetrable structure where ventilation does not occur, or hardly so. In this case a pattern 6 of dots has been chosen, although a line pattern or any other embodiment can be chosen instead. An added advantage of such a pattern is that the fabric thereby also becomes stronger, whereby it is more durable from a mechanical viewpoint.

Although the invention has been further elucidated above on the basis of only a few embodiments, it will be apparent that the invention is by no means limited to the given examples. On the contrary, many other variations and embodiments are possible for an average skilled person within the scope of the invention. The materials applied here can for instance be replaced by other appropriate materials. Instead of being arranged in the fabric material, the anti-fungal and anti-algal agent can for instance also be arranged on the fabric material, particularly for instance in the lacquer pattern which can be subsequently arranged on the fabric to regulate the ventilation thereof. In this latter case a process step is also saved. The first substance can also be formed by a reactive compound instead of a metal or other element Other methods of arranging the first substance are also possible. The first substance can thus for instance be braided or woven through the material of the filter or otherwise anchored therein in the form of one or more threads so as to perform its anti-fungal function. It is also possible to incorporate the first substance in the form of beads or wafers in the filter tape, for instance by scattering the macroscopic particles thereover and rolling them into the filter cloth, optionally at increased temperature, thus anchoring them durably. Although in both cases the first substance is arranged in relatively very localized manner, a sufficiently large active area is attainable owing to migration of the water-soluble active second substance formed therefrom in the moist filter tape. All in all, numerous options are available to the skilled person for adjusting the exact structure of the filter tape to the specific requirements while retaining the advantages of the present invention.

1. Filter tape comprising a dustproof but ventilating textile fabric which is provided with an anti-fungal and anti-algal agent, characterized in that the anti-fungal and anti-algal agent comprises a first substance which is not water-soluble, or hardly so, but which is nevertheless capable of entering into an in situ reaction with forming of an active second substance, which is considerably more readily water-soluble and is toxic to fungi and algae.

2. Filter tape as claimed in claim 1, characterized in that the first substance is a metal and the second substance comprises an associated metal oxide which is at least moderately soluble in water.

3. Filter tape as claimed in claim 2, characterized in that the metal comprises copper and the active substance copper oxide.

4. Filter tape as claimed in claim 1, 2 or 3, characterized in that the textile fabric comprises fibres which are at least to a considerable extent at least practically encased with the first substance.

5. Filter tape as claimed in one or more of the foregoing claims, characterized in that the textile fabric is provided with a pattern which at least almost completely closes the textile fabric locally but leaves ventilating parts open therebetween.

6. Filter tape as claimed in claim 5, characterized in that the pattern is arranged in the textile fabric itself by compacting the material thereof mechanically and/or thermally in pattern-like manner.

7. Filter tape as claimed in claim 5, characterized in that the pattern comprises an at least practically airtight material which is arranged on the textile fabric.

8. Filter tape as claimed in claim 7, characterized in that the pattern contains the first substance.

9. Filter tape as claimed in one or more of the foregoing claims, characterized in that the textile fabric is provided along opposite longitudinal sides thereof with at least a trace of an adhesive.

10. Filter tape as claimed in claim 9, characterized in that the adhesive is self-adhesive and is covered with a removable protective sheet.
